(19) United States
(12) Patent Application Publication
(10) Pub. No.: US 2015/0167768 A1
(43) Pub. Date: Jun. 18, 2015

(54) Carbon Fiber Composite Springs And Method of Making Thereof

(71) Applicant: Jing Zhao, Winchester, MA (US)

(72) Inventor: Jing Zhao, Winchester, MA (US)

(21) Appl. No.: 14/271,424

(22) Filed: May 6, 2014

Related U.S. Application Data
(60) Provisional application No. 61/916,752, filed on Dec. 16, 2013.

(51) Int. Cl. F16F 1/368; A43B 13/18; A42B 3/04; A47C 7/02

(52) U.S. Cl. CPC F16F 1/368; A47C 7/025; A43B 13/181; A42B 3/04

(57) ABSTRACT

A bow shaped, sheet-thin, carbon fiber spring that utilizes the material's special characteristics is disclosed. Carbon fiber filaments are laid along the bow curvature. Cushions made of carbon fiber composite springs provide performance improvements in better shock absorption, lighter weight, better fire safety, and longer life without performance degradation. Example embodiments are shoes, helmets, and seats.

### CROSS-REFERENCE TO RELATED APPLICATIONS

This application claims priority to U.S. Provisional Application No. 61/916752 filed Dec. 16, 2013, entitled Compact Carbon Fiber Composite springs For force Damping, the contents of which are hereby incorporated by reference in their entirety and for all purposes.

### BACKGROUND OF THE INVENTION

Spring or spring like structures have been traditionally made using metals. There are applications that require springs of lightweight, such as in aerospace and automobile for fuel efficiency, cushions in helmets and shoes for better protection. Lightweight springs, if can be realized, will offer unprecedented benefits for these applications. The recent developments in carbon fiber composites have created an unique route for fabrication lightweight springs. However, carbon fiber composites have challenges for spring construction: 1) less flexible; 2) brittle; and 3) high anisotropic. The known spring configurations are intrinsically unsuited for carbon fiber composite springs, resulting in springs of smaller deformation and lower spring constant, consequently smaller capacity to load.

Therefore, what is needed for a new spring configuration that fully utilizes carbon fiber's unique properties to provide large elastic deformation and large transfer force in a compact form as well as using minimum amounts of materials as well as low cost manufacturing for wide applications.

### SUMMARY

The invention concerns a carbon fiber composite spring, comprising a bow shaped shell of elastically deformable material made of carbon fibers laying substantially unidirectional along the curvature from one end to the other having certain thickness to length ratio. In addition, they are often provided with an upper surface adjacent to the curvature center and a lower surfaces adjacent to the two ends which are often bended through which the loads are applied. The inventive carbon fiber spring configuration fully takes advantage of carbon fiber's unique properties to provide elastic flexibility and higher spring constant, as well as ability to provide large transfer forces in a compact form. Economical manufacturing methods of making thereof are disclosed herein, allowing suitable product applications such as in shoes, helmets and seats.

In one embodiment, carbon fiber composite materials are formed into a bow shaped band-stripe, having a sheet-thin arched waving with carbon fibers laying substantially along the curvature from one end to the other. The bow shaped band-stripe may also have bended ends for applying load. The high mechanical strength of the carbon fibers in the composite sheet shaped the bow structure thus unexpectedly produces a high load capacity with large deformation strength and a high strength-to-weight ratio. This bow shaped carbon fiber band-stripe is then capable of being used as structural or shear springs.

In one aspect of the embodiment, two such arched carbon fiber band-stripes across each other forming an arched cross with or without bended ends. These carbon fiber arched crosses are then capable of being utilized as structural or shear springs.

In one aspect of the embodiment, the ends of two arched carbon fiber band-stripes are pressed together while their arch curvatures are curved to opposite directions forming a ring-band or an ellipsed ring-band. These carbon fiber ring-bands are then capable of being utilized as structural or shear springs.

In one aspect of the embodiment, the carbon fiber spring comprises two large carbon fiber brace ends bending as half-folded sheets and bridged with an arched carbon fiber band-stripe. These carbon fiber springs are then capable of being utilized as structural or shear springs.

In one aspect of the embodiment, the arch shaped carbon fiber band-stripes are fabricated by using two-piece molding process in which one mold is made from hard and rigid material such as a composite material replica of the sample or machined from drawings using wood or metal, and the other is a soft mold made of silicon or other polymer rubber materials by pouring into the hard mold before it is solidified. To fabricate a complex carbon fiber composite spring, pre-preg or carbon fibers soaked with resin are first put into the hard mold and pressed between the hard mold and the soft silicon matching mold, and followed by curing at an elevated temperature. Because of the large thermal expansion of silicon materials, the expansion of the soft mold during heating will hold carbon fiber tightly onto the hard molded contour and simultaneously squeeze out excess resin, eliminating the need for vacuum bagging or high pressure autoclaving.

In one embodiment, the carbon fiber or carbon fiber composite springs are configured in size and weight suitable for being used in shoe soles.

In one embodiment, the carbon fiber or carbon fiber composite springs are configured in size and weight suitable for being used in helmets.

In one embodiment, the carbon fiber or carbon fiber composite springs are configured in size and weight suitable for being used in seats and chair structures.

The described spring designs and their cushions offer many vanguard advantages. First, to take advantage of carbon fibers' extremely large tensile strength, the spring band-sheet is curved along the carbon fibers extending direction. The spring configuration thus intrinsically provides exceptional counter forces to large loads in an extremely thin compact format. Secondly, because of the thin sheet feature, the spring configuration allows for maximum free deformation movement, thus a deformation capability of over 80% of its virgin height, resulting in large kinetic energy absorption and storage. Thirdly, due to the carbon fiber feature, it is extremely lightweight, lighter than polymer foam cushions of same overall thickness. Fourthly, the sheet-band spring design allows efficient material use without generating much waste and can be fabricated from layered carbon fibers composite sheet without having to assort to the more expensive weaved cloth format. Fifthly, the springs provide highly efficient energy storage and recovery capabilities. Sixthly, by varying the bow shape and thickness, packing arrangement, the spring performance can be tailored according to various force level requirement and needs. Finally, it can be economically fabricated by composite molding, enabling wide consumer acceptable applications with vintage quality.

The invention can provide a lightweight and comfortable shoe that dynamically cushions the wearer's foot against the impact forces encountered in physical activities with springs made of carbon fiber based materials. The invention can provide a helmet having carbon fiber spring cushions that drastically increase its damping capacity against impacts, preventing concussion. The present invention can provide thinner, lighter seats with better cushioning, ideal for airplane seats to increase fuel efficiency, passenger carrying capacity, fire safety and comfort, as well as reducing industrial waste from frequently replaced old foam cushions.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1A shows a perspective view of an example carbon fiber spring having an arch shaped band-stripe spring configuration, made of carbon fiber composite, in its original position in accordance with this application.

FIG. 1B shows the cushion of FIG. 1A in compressed position in accordance with this application.

FIG. 2A shows a perspective view of an example arched-cross spring configuration, made of carbon fiber composite, in its original position in accordance with this application.

FIG. 2B shows the spring of FIG. 2A in compressed position in accordance with this application.

FIG. 3A shows a perspective view of an example ellipsed ring spring configuration, made of carbon fiber composite, in its original position in accordance with this application.

FIG. 3B shows the spring of FIG. 3A in compressed position in accordance with this application.

FIG. 4 shows a perspective view of an example brace spring configuration with half-folded ends, made of carbon fiber composite, in its original position in accordance with this application.

FIG. 5 shows a perspective view of an example complex brace spring configuration with connected half-folded ends, made of carbon fiber composite, in its original position in accordance with this application.

FIG. 6 shows a perspective view of an example complex spring configuration with inward-bended ends and connected top portion, made of carbon fiber composite, in its original position in accordance with this application.

FIG. 7 shows a transparent perspective view of a two-piece mold made of hard and soft materials respectively, in demonstrating the method of making, in accordance with this application.

FIG. 8 shows a perspective view of an example shoe having a sole cushion configured with carbon fiber springs in accordance with this application.

FIG. 9 shows a comparison of deformation strength under various weight forces between a shoe sole having the spring of FIG. 1A, a conventional rubber shoe foam, and a metal spring in accordance with this application.

FIG. 10 shows a perspective view of an example helmet having a cushion configured with carbon fiber springs in accordance with this application.

FIG. 11 shows a perspective view of an example seat having a cushion configured with carbon fiber springs in accordance with this application.

### DETAILED DESCRIPTION OF THE INVENTION

The numerous innovative teachings of the present application will be described with particular reference to presently preferred embodiments (by way of example, and not of limitation). The present application describes several embodiments, and none of the statements below should be taken as limiting the claims generally. For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help the understanding of embodiments of the invention. The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition. Although the term “bounciness” or resiliently is utilized other equivalent terms may also be used to describe the resistance to deformation of carbon fiber spring. It should also be noted that the term “spring” as utilized herein is generic and encompasses various configurations and designs, such as those shown in the drawings or described in the specification. In this application, “sheet-band”, “curved like”, a “shell” or “bow shape” are used interexchangeable, to describe a curved band of carbon fiber or carbon fiber composite thin sheet that has a curvature shape.

Despite the challenges, it has been recognized that carbon fiber composites have significant advantages for spring construction herein over conventional heat-treated steel. The term “carbon fibers” are used herein in the generic sense and are intended to include graphite fibers as well as amorphous carbon fibers. Deformation of a spring stores the kinetic energy into potential energy thus providing the shock absorption as well as bouncing effect when releasing. The modulus of elasticity (flexibility) of the carbon fiber composite is approximately that of the steel. On the other hand, the tensile strength of carbon fiber composite is about three times of that of steel. This difference means that the carbon fiber structure can bear load nearly three times as much as the load by a steel structure. In addition, the carbon fiber composites have significantly less weight per volume—only about 20% that of steel. Conversely, a carbon fiber composite spring having the same resistance as a steel spring may only weigh about 1/15 that of the steel spring. Carbon fiber springs are also high chemical resistance and low thermal expansion, can be more durable than steel springs and without concerns of rust.

However, carbon fiber spring performance is greatly influenced by the device configuration. Since carbon fiber is relatively soft to bend along the fiber strand, it does not generate sufficient tension to bounce in coil or leaf configuration to be used as a spring. The carbon fiber composite springs made of conventional leaf and coil configurations show poorer loading capacity than its metal counterparts. To utilize carbon fiber composite's unique high tensile strength along the fibers, special spring configurations have to be designed and tested that can achieve large force loading capability.

Carbon Fiber Spring Design

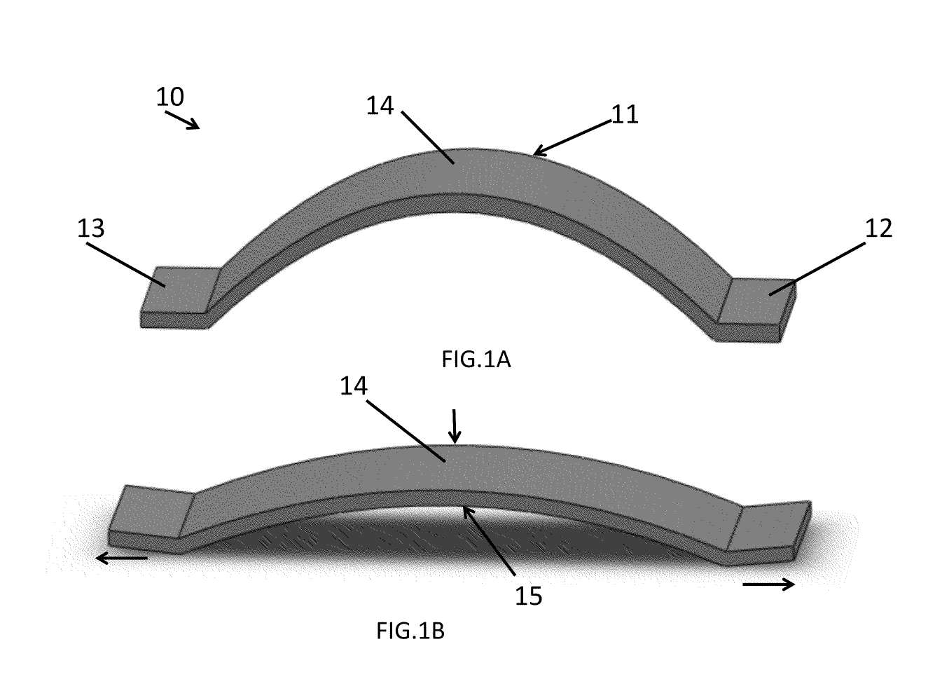

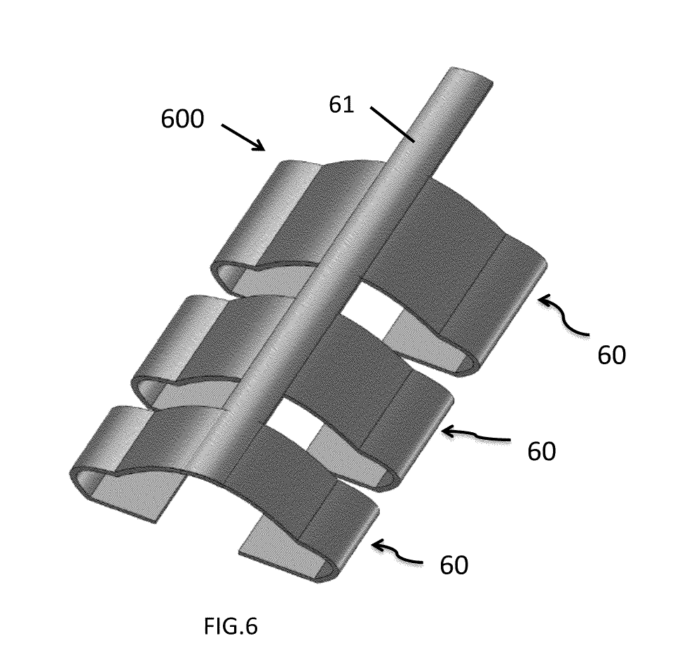

The first challenge for carbon fiber composite (CFC) spring construction is to achieve elastic flexibility in a very hard and brittle material. The inventive springs overcome this by utilizing thin sheets consisting carbon fibers more or less aligned in one direction in the form of bundled stow or weaved fabric. When the length to the thickness ratio above certain value, this carbon composite thin sheet becomes flexible along the axis of the fiber strands. The second challenge is to achieve large responsive force or large load. The inventive springs accomplish this by bow shape construction. FIG. 1A shows bow shaped CFC spring 10 made of a thin sheet carbon fiber composite pre-form into a shell or bow shape, having carbon fibers laying substantially along the curvature from end 12 to end 13. The spring 10 features at least one circular portion 14 connecting two peripheral feet portions 12 and 13 on both ends, which are bended for ease of applications. Alternatively, feet portions 12 and 12 can bend inwardly towards each other as shown in FIG. 6, having a dimensioned bending brace structure.

In reference to FIG. 1B, the carbon fiber spring 10 collapses its bow curvature to nearly flat position 15 upon the applying of a sufficiently large force on the curvature top 14. It absorbs the impact energy by building up internal tension along the curvature. Spring 10 restores the original bow shape when the force removed, creating a bounce effect in the process. During the spring action, the center of curvature 14 moves down vertically while spring 10 flattens out as the two feet 12 and 13 move horizontally.

The carbon fiber springs preferably have a length (from one end to another end of the curvature) to thickness ratio >10 to maintain flexibility and reliability.

This sheet-band spring configuration also provides a compact low profile which allows the springs be configured into tight space that is especially suited for shoe and helmet applications. The center and edges of the spring are preferably the mounting points.

In the alternative, carbon fiber composite spring 10 may be pre-configured in a relatively flat shape with a shallow curvature as shown in FIG. 1B to function as compression spring, in which the carbon fiber composite spring can be pushed to curve up upon application of a force as shown in FIG. 1A.

The bow shape also enables internal stress distributions along the curvature thus along the strenuous carbon fibers, greatly enhancing durability of the internal shearing force. This type of spring can also be utilized in key structural points to overcome carbon fiber composite brittleness with tendency of cracking, such as in chairs or other structures such as bicycles and airplane bodies.

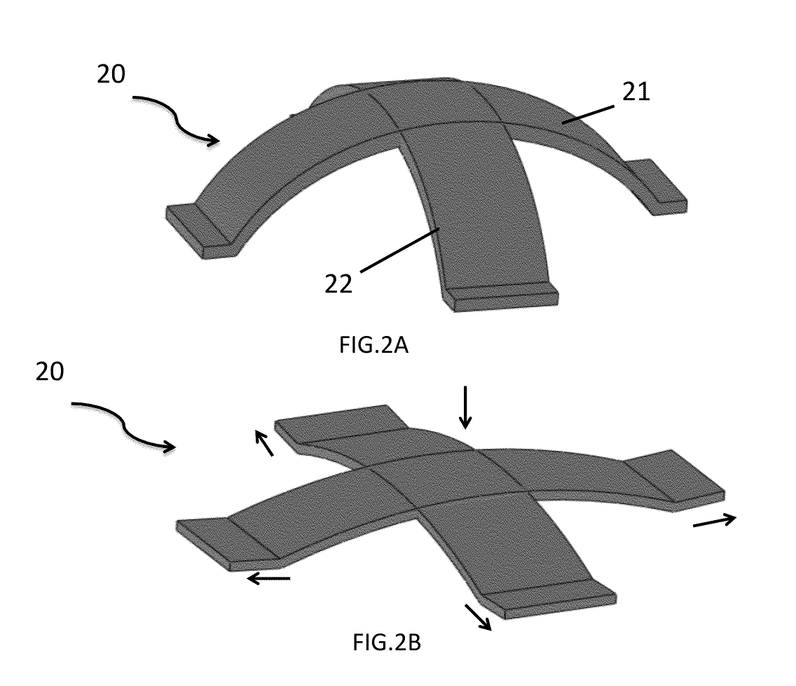

In reference to FIG. 2A and 2B, more than one CF bow springs can be assembled together into a single spring device to permit two dimensional spring motion as shown in spring 20. Spring portion 21 and 22 may be crossingly fixed with each. Moreover, the thickness along the spring sheet-band can be varied to specifically satisfy the various force loading conditions of a specific application in order to provide optimum dampening response.

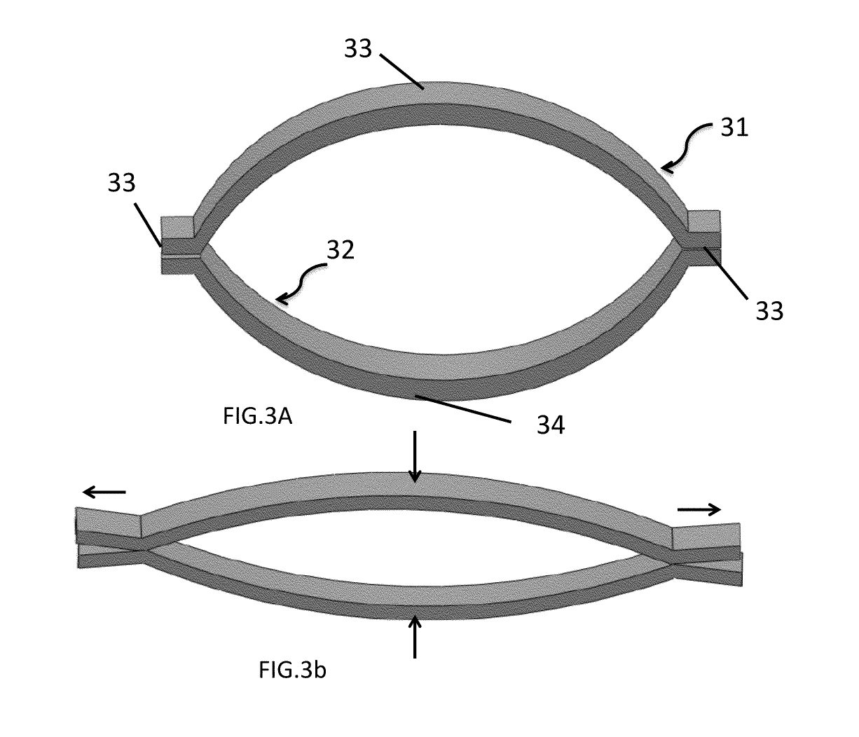

Multiple CFC bow springs can be stacked up to achieve added spring function. Two example embodiments are disclosed here. In reference to FIG. 3A and 3B, two bow CFC springs 31 and 32 are connected at their feet at 33 and 34 with their curvature in opposite directions to form a ring-like structure so that the spring moves in the vertical direction with twice of the displacement as that of the single spring. The surface portion 33 and 34 may serve as anchoring points to apply force and form anchor.

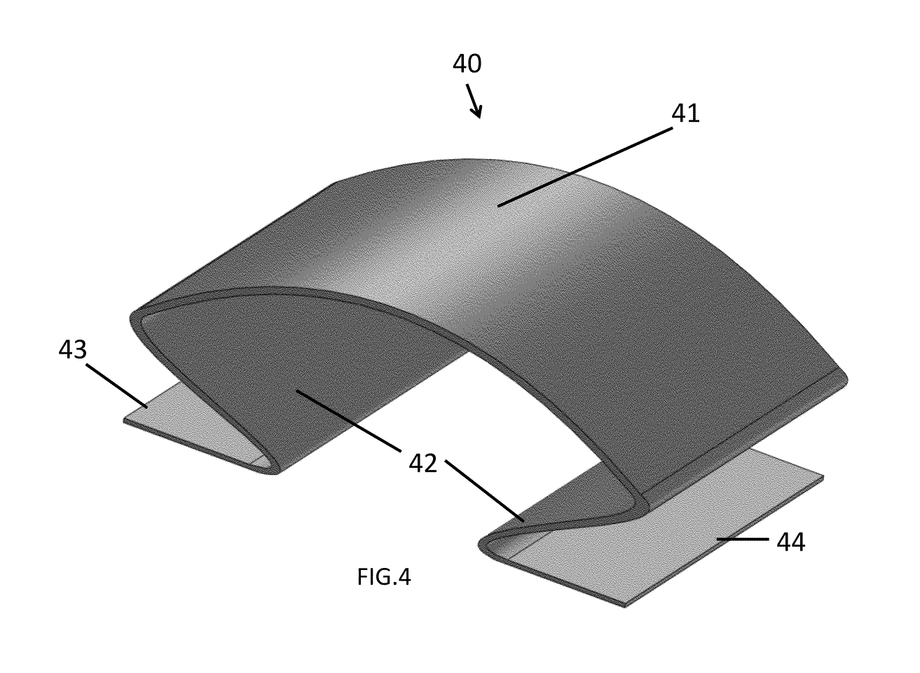

In reference to FIG. 4 an alternative bow spring design 40 is disclosed that essentially stacking bow curvature portion 41 and foot portions 43 and 44 together with respective stronger and curved support braces 42 having twice the displacement. The CFC spring 40 features compactness with two slightly curved sheet-band braces 42 arranged in opposite directions that are bridged with a sheet-band 41, along with two feet 43 and 44. The spring device is designed to move vertically when force is applied and released. The two feet 43 and 44 and the top 41 can be conveniently used as anchoring points. The top bow spring 41 can be made relatively softer by using thinner sheet while the bottom bow spring sheets 42 can be made harder by using thicker sheet so that the complex spring has is pliable yet can still support a large force.

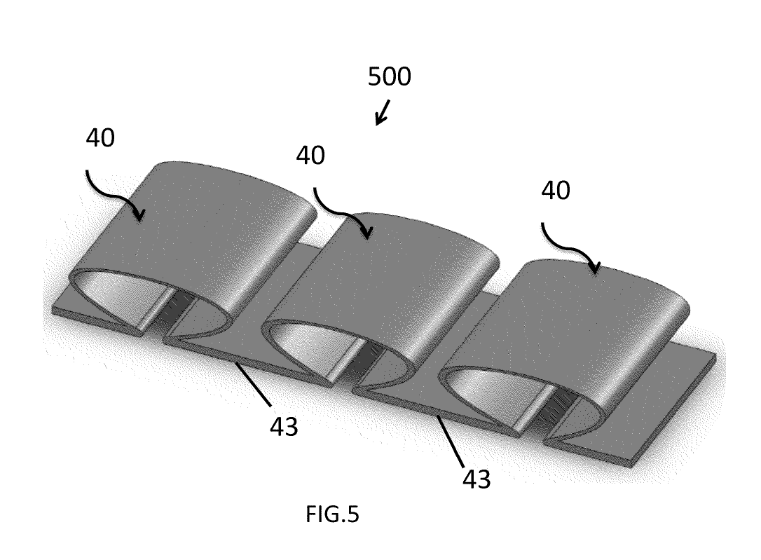

Many CFC springs can also be connected together to form a very large and flexible spring. Two example embodiments are disclosed. In reference in FIG. 5, three bow CFC springs 40 are connected near their feet in one direction to form a long belt device 500 in which surface portion 40s may serve as a point to apply force and feet 43 as anchoring points. This way the belt spring is flexible to fit in which each element response to local force. The belt spring 500 can be extended well beyond three elements to cover large areas, such as to fit inside a curved helmet, a contour seat or a large bed.

Another example spring 600 is shown in FIG. 6, three bow CF springs 60 having inwardly bended feet are connected via an anchor strip 61 near their top in one direction to form a spring 600 having some flexibility between. Spring 600 is well suited for shoe sole in which foot movement requires flexibility among each force damping spring elements.

The described spring designs offer many vanguard advantages. First, because of anisotropic construction using unidirectional carbon fiber and the thin sheet format, the spring configuration allows for maximum elastic deformation movement, thus a deformation capability of over 80% of its virgin height becomes achievable. Second, to take advantage of carbon fibers' extremely large tensile strength, the spring band-sheet is pre-curved along the carbon fibers strand direction. The spring configuration thus intrinsically provides exceptional counter forces to large loads. Third, due to the carbon fiber feature, it is extremely lightweight, lighter than polymer foam cushions of same overall thickness. Fourth, the sheet-band spring design allows efficient material use without generating much waste and can be fabricated from unidirectionally layered carbon fibers sheet without having to assort to the more expensive weaved cloth format. Fifth, the springs provide large kinetic energy absorption or storage and efficient energy recovery capabilities due to its large elastic displacement and force load. Sixth, by varying the bow shape and thickness, packing arrangement, the spring performance can be tailored according to various force level requirement and needs. Finally, it can be economically fabricated by composite molding, enabling wide consumer acceptable applications.

Carbon Fiber Spring Making

Currently, carbon fiber composite parts of various shapes are made primarily with pre-preg materials or raw carbon fibers with resin infusions using vacuum bagging or autoclave processes. These processes have been decade old industry standards where vacuum pressure is essentially used to tightly hold the carbon fiber composite onto the mold and to enable uniform control of the epoxy soaking during the elevated temperature curing. They are complex, labor intense, time consuming, high capital requiring and materially wasteful, resulting in high cost for carbon fiber composite parts. These expensive processes have limited carbon fiber materials to the high end uses such as aerospace. Common consumers have not been able to afford the use of carbon fiber materials.

In order to allow carbon fiber springs be used to consumer products, a cost effective fabrication process and associated tooling is developed. This novel fabrication process facilitates low cost and high throughput production of carbon fiber composite components with little material waste.

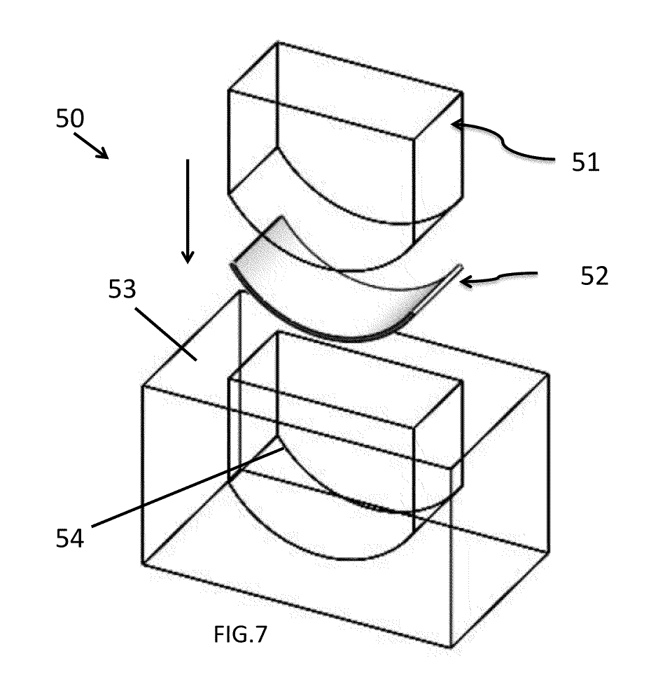

In references to FIG. 7, a two-piece bow shape mold 50 is shown, in which one is a hard mold 53 and another is a soft matching mold 51. The hard mold 53 can be made from a composite material replica of the sample or machined from drawings using wood or metal. The soft mold 51 is made of primarily silicone or other polymer rubber materials by pouring into the hard mold with wax sheet spacer before it is solidified.

As shown, to produce a carbon fiber composite spring 52, prepreg or resin soaked carbon fiber stows are placed into hard mold 53 with the carbon fibers laying along the curvature 54; then soft silicon matching mold 51 is fitted onto the carbon fiber composite sheet within hard mold 53 sandwiching the carbon fiber composite sheet in between, which is then followed by curing the sandwich at an elevated temperature. Because of the large thermal expansion ratio of silicone materials, soft mold 51 expands extensively during heating, providing two critical functions: carbon fiber sheet 52 is tightly pressed onto the contour of hard mold 53 while the excess resin in carbon fiber sheet 52 is squeezed out by the expansion of soft mold 51.

This new process eliminates the need for vacuum bagging or high pressure autoclaving, as well as wasting materials in molding. This process is especially designed for complex carbon fiber device fabrication, since the soft mold is naturally molding releasing and reusable. Therefore, the inventive rubber molding is advantageous for producing carbon fiber composite springs with low cost, fast processing time, and little material waste. In bow spring fabrication, it may be preferable to lay unidirectional carbon fiber stows along a bow curvature and cure with resin at an elevated temperature. This configuration fully utilizes the large tensile strength of carbon fiber to maximize the loading force and thus kinetic energy absorption capacity.

Carbon Fiber-Spring Cushioned Shoes

Current shoes are inadequate to prevent damage to the human body resulting from repetitive ambulatory and weight bearing activities on hard surfaces due to their poor shock absorbing capability. During a body's stride, the entire body weight transfers onto a single foot and the return force from hitting a hard surface can reach about three times that of the body weight while walking and eight times while running, which is harmful when transmitted up the bone structure. In addition, the inability of current shoes to substantially attenuate the shock force can result in cumulative muscle fatigue and diminished endurance especially when performing repetitive activities. This is because the body's muscles naturally respond to the sharp rise in impact force by momentarily tensing to prevent soft tissues and internal organs.

For many groups of people, such as athletes, soldiers, laborers, nurses, overweight people or older people, long-term subjection of the foot to the impacts of hitting hard ground often cause ankle wobble, knee pain, back pain, muscle fatigue or, in some cases, shin splints.

Presently, deformable rubber polymer composites or polymer foams are the primary material used as part of the sole to attenuate the force from hitting hard surfaces. This material has many deficiencies: small deformation thus inadequate shock-absorbing capacity, heavy that often constitutes the main weight of a shoe, loss of elasticity after short use, and hardening during cold temperatures.

Increasing shoe sole elastic deformation has long been sought after to improve shock absorption. Over the years, numerous approaches have been made, include incorporating chamber cushions into the sole that are filled with gas or liquid, or incorporating plastic and metal springs, but they are limited due to the fundamental material properties. Although air or liquid filled sole chambers increase absorption, their overall deformation displacements in response to a force impact are small. Incorporating a leaf type bending spring made of plastic materials has been disclosed in several patents, including U.S. Pat. No. 5,461,800 A and US20110138652 A1. However, because plastic materials are not purely elastic so they are easily deformed, consequently these shoes are made rigidly with little displacement or flexibility, resulting in minimum shock absorbing improvement. Since little energy can be stored in these plastic springs, these shoes do not provide substantial bounce. Using metal springs improves shock absorption and energy storage/recovery. However, shoes incorporating metal springs are too heavy and too bulky to be comfortable to wear, because large metal springs are required to support a typical human body weight. One such example is the “Z-coil” shoe disclosed in U.S. Pat. No. 5,435,079 A.

Using CFC springs in shoe sole can drastically increase its shock absorber level has not been attainable before. This is due to CFC spring's large compressible ratio, which can reach over 80%, while current performance shoes made of polymer foams have compressible ratio above 10%. Since energy absorption is approximately proportional to cushion's deformation, the shock absorption improvement of a CFC shoe can reach about 7 times that of the conventional foam shoes, sufficiently to reduce the impact forces for most athletic activities.

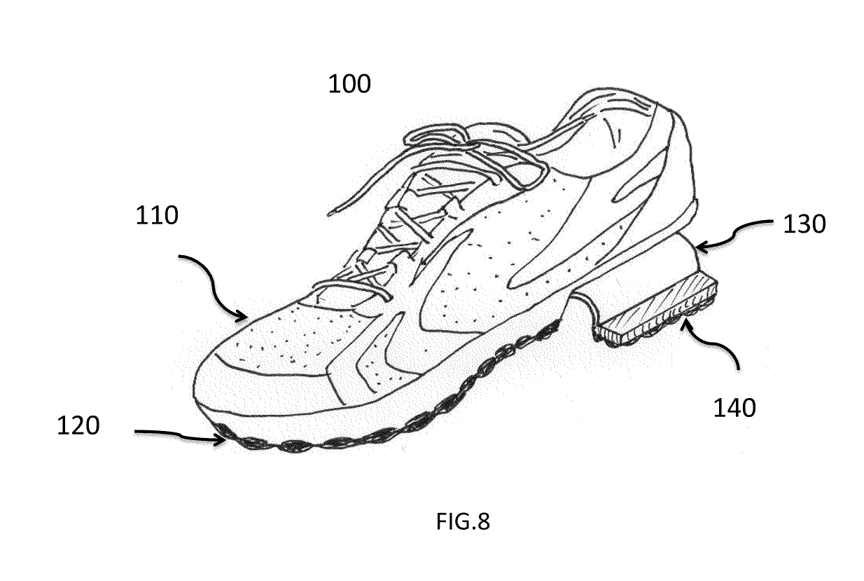

FIG. 8 illustrates an inventive shoe 100 which incorporates CFC bow springs 10 described in FIG. 1A as the back spring 130, that cushions the heel against impact forces. Carbon fiber springs can also be incorporated in the front sole 120 of a shoe to cushion the inner and out balls of the feet, which often land ground first. Shoe 100 is further comprised of an upper 110 which is attached to the sole. Shoe 100 is also comprised of an out sole 140 to touch the ground made of a layer of hard rubber covering the springs bottom, providing traction and minimizing sound.

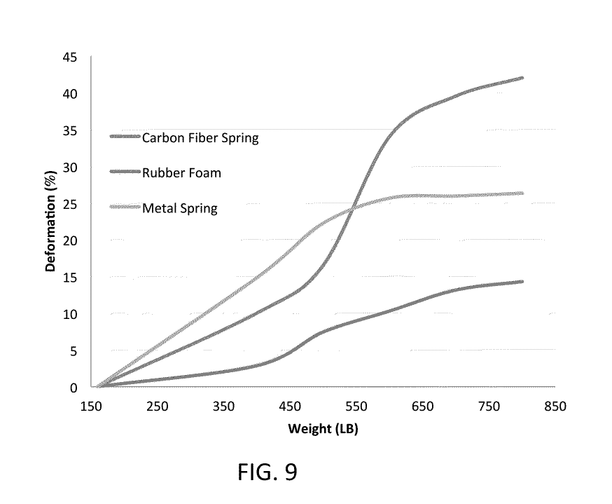

In reference to FIG. 9, a comparison of the elasticity between a prototype CFC spring shoe sole 130 and a running shoe sole and a commercial shoe containing metal coil springs. Under the same force, CFC shoe sole shows a much larger deformation ratio than a rubber foam shoe sole, about 3 times improvement. FIG. 9 also shows CFC spring shoe sole continues to deform thus damper at large force while meal spring shoe sole saturates due to short coil length. Moreover, in the test the CFC spring sole is four times lighter than metal spring sole, and two times lighter than the rubber foam sole.

The spring configuration of this invention features compactness that does not increase shoe sole thickness yet still provides unprecedentedly large resistive force to counter an impact. Shoe 100 is also advantageously lightweight without the need to use a large amount of rubber like materials. Since there are substantial vertical elastic spring movements that do not consume energy, the inventive shoes are extremely “bouncy”, providing a feel of soft landing as well as power take-off with extra lift and energy return. By varying the spring thickness along the bow curvature, the inventive shoe can convert the vertical downward energy into both a horizontal pushing force and an upward lifting force with each step. Furthermore, by making the inner side that is closer to the other foot, of the spring thinner than that of the outer section, the inventive shoe can also maintain posture and balance torque to enhance the natural foot progression during gait.

The inventive shoe can incorporate other carbon fiber springs in various sole locations and of various shapes and configurations based on the bow principle, including the inventive spring configurations depicted in FIGS. 1 to 6.

Carbon Fiber-Spring Cushioned Helmet

Although current helmets are effective in preventing skull fracture from an impact due to a variety of activities, including sports, driving and construction, they are inadequate in preventing brain injury such as a concussion. Studies show that each year over 1 million Americans experience concussions. The traumatic brain injury can be serious, causing permanent disability or death. Present helmets use deformable polymer foam materials that are too thin to isolate a strong shock force to reach the soft brain tissues. A concussion occurs when a brain's soft tissue moves in reaction to the sudden force. Increasing the foam thickness adversely increases the size and weight of the helmet, resulting in a significant loss of the wearer's agility and comfort, making the solution impractical.

Furthermore, foamed materials lose cushioning properties and “wear-out,” as they irreversibly degrade under the repeated compression and shearing loads. In addition, the dynamic properties of the plastic foamed materials are strongly temperature dependent. They become hard in colder temperatures and thus lose their deformable cushioning properties. Many foam based helmets also have a deficiency of poor ventilation that traps excessive heat and induces uncomfortable sweating.

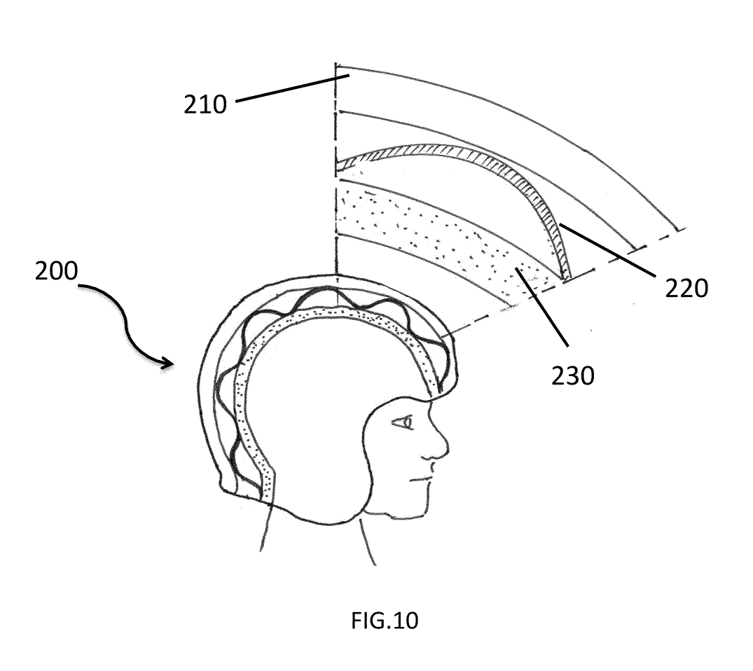

The inventive carbon fiber springs of the configuration shown in FIG. 10 offers a novel solution that drastically increase helmet shock absorption, thus reducing the injury to soft brain tissue. The inventive helmet 200 comprises an outer helmet shell 210 and an inner shell 230 with the inventive bow shaped carbon fiber springs 220 placed in between. This compact carbon fiber springs in the helmet respond to an outside impact with a much larger deformation than previously possible. The helmet absorbs significantly more kinetic energy than current foam cushion, preventing concussions. The defense against concussions is achieved with a kinetic offense, with the exceptional shock absorbing carbon fiber springs having more than 7 folds energy absorption capacity and much large dynamic force range than foam. The carbon fiber based helmet further offers the comfort of lighter weight, as well as ventilation function due to the air space. The free movement of the incorporated bow shaped springs within the helmet double shell layers also provides anti-rotation counter forces that would otherwise be damaging. It does this by converting the torque created by rotation into spring compression.

Concepts of incorporating metal springs have been proposed previously, including US2010/0083424 A1 and US 2013/0185837 A1, however, those are unpractical due to the heavy weight of metal. The inventive carbon fiber composite spring helmet fundamentally overcomes the previous design limitations.

Carbon Fiber-Spring Cushioned Seats

Carbon fiber composite seats promise to reduce both the thickness and the weight of aircraft seating, advantageously adding more seats and reducing weight for airplanes. For commercial aircraft, each pound of reduction is worth $500 in fuel savings using the present value. However, airplane seats need to meet stringent FAA strength requirements of withstanding 16 times the force of gravity and passing crash testing, which post a challenge for carbon fiber composite material.

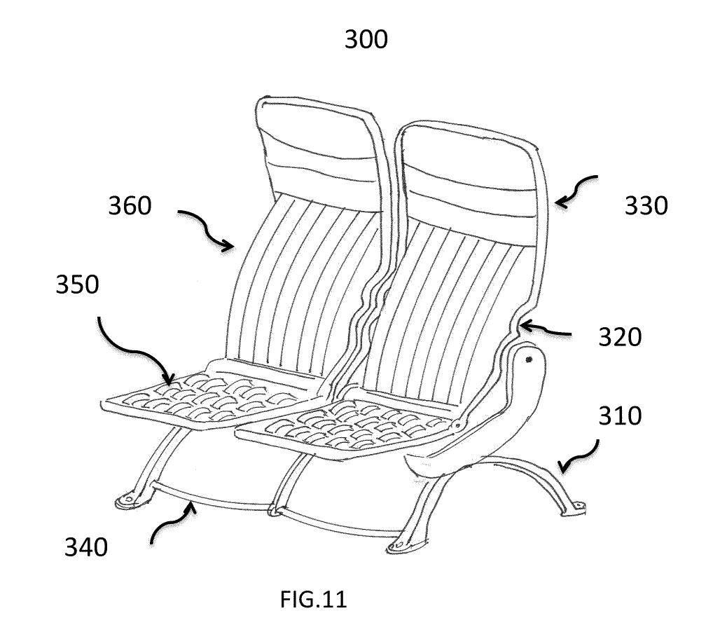

In reference to FIG. 11, the inventive seat 300 incorporates carbon fiber bow shaped spring designs into the seat structure 310, 320, 330, 340 to facilitate its flexibility. Carbon fiber composites have the drawback of brittleness; although they are strong, they are prone to cracking upon a large impact. Our inventive seat design overcomes this deficiency by incorporating bow shaped spring designs in key structure supporting locations so that the seat structure will bend instead of break in response to a large force impact, such as in a crash landing. This inventive bend-don't-break design overcomes the inherited fracture reliability issue of carbon fiber seats.

The inventive seat 300 further features an all CFC seat cushions 350 and back cushion 360 for improved comfort and maximum reductions in weight and size. It uses bow springs to form cushions on both the bottom and the back. Due to their large deformation capacity and varying resistive forces with various spring curvatures and thicknesses, the inventive spring seat is exceptionally comfortable and substantially reduces fatigue caused by vibrations. Many other variations of spring configurations based on the bow principle can also be used including all the CFC springs disclosed above. In addition, the inventive seat comprised of carbon fiber spring cushions increases survivability, since it generates an extremely small amount of toxic gas in case of a fire. Moreover, its spring cushion performance does not degrade over time, eliminating the industrial waste of replacing traditional foam cushions every five years. Therefore, the benefits of carrying more passengers with better fuel efficiency, more comfort, and better safety in the case of both a fire and a crash are highly compelling reasons to adopt carbon fiber seats in airplanes.

Numerous characteristics and advantages of the invention have been set forth in the foregoing description, together with details of the structure and function of the invention, and the novel features hereof are pointed out in the appended claims. The disclosure, however, is illustrative only, and changes may be made in detail, especially in matters, shape, size, and arrangement of parts, within the principle of the invention, to the full extend indicated by the broad general meaning of the terms in which the appended claims are expressed.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

What is claimed:

1. A carbon-fiber composite spring device, comprising:
an elongated carbon fiber composite sheet-band with a curvature configuration, a long dimension, a wide dimension and a thick dimension;
the long dimension extending from a first edge to a second edge; the wide dimension extending from a third edge to a fourth edge; said long dimension being longer than said wide dimension; said thick dimension being less than 1/10 of said long dimension;
wherein said curvature configuration has a central curve along said long dimension, said central curve is configured to receive external force; and carbon fiber filaments are molded along said long dimension across said central curve.

2. The carbon fiber spring of claim 1, wherein said carbon fiber filaments are soaked with plastic resin materials.

3. The carbon fiber spring of claim 1, wherein said curvature configuration becomes substantially flat upon receiving an external force from convex side.

4. The carbon fiber spring of claim 1, wherein said curvature configuration becomes substantially curved upon receiving an external force from concave side.

5. The carbon fiber spring of claim 1, wherein said curvature configuration has a thinner thickness than said first edge and/or said second edge, and said first edge and second edge are bended to form a bow end.

6. The carbon fiber spring of claim 1, wherein said first edge and said second edge are bended towards each other.

7. The carbon fiber spring of claim 1, wherein said carbon fiber spring is a component in a shoe sole.

8. The carbon fiber spring of claim 1, wherein said carbon fiber spring is a component in a helmet shell.

9. The carbon fiber spring of claim 1, wherein said carbon fiber spring is a component in a seat or chair.

10. The carbon fiber spring of claim 1, wherein said sheet band is a first portion of said carbon-fiber spring, said carbon-fiber spring has a second portion, said second portion is dimensionally configured the same as the first portion; and said first portion and said second portion cross-contact with each other at their respective central curves.

11. The carbon fiber spring of claim 10, wherein said carbon fiber spring is a component in a shoe sole.

12. The carbon fiber spring of claim 10, wherein said carbon fiber spring is a component in a helmet shell.

13. The carbon fiber spring of claim 10, wherein said carbon fiber spring is a component in a seat or chair.

14. The carbon fiber spring of claim 10, wherein said first portion and said second portion inter-contact with each other at their respective first edge and second edge, forming a band ring.

15. The carbon fiber spring of claim 14, wherein said carbon fiber spring is a component in a shoe sole.

16. The carbon fiber spring of claim 14, wherein said carbon fiber spring is a component in a helmet shell.

17. The carbon fiber spring of claim 14, wherein said carbon fiber spring is a component in a seat or chair.

18. The carbon fiber spring of claim 1, wherein said sheet band is a first portion of said carbon-fiber spring, said carbon-fiber spring further has a second portion and a third portion, said second portion is a pair of curved carbon-fiber sheets, and said third portion is a pair of carbon-fiber plates; said second and third portion have matching ends forming two brace supports of the carbon fiber spring, said second portion has matching ends that inter-contact respectively with the first edge and the second edge of said sheet band of the first portion.

19. The carbon fiber spring of claim 18, wherein said carbon fiber spring is a component in a shoe sole.

20. The carbon fiber spring of claim 18, wherein said carbon fiber spring is a component in a helmet shell.

21. The carbon fiber spring of claim 18, wherein said carbon fiber spring is a component in a seat or chair.

22. The carbon fiber spring of claim 1, wherein said sheet band is a first unit of a plurality units wherein said first unit is in parallel with a second unit, the first edge of said unit is physically integrated with the second edge of the neighboring unit.

23. The carbon fiber spring of claim 1, wherein said sheet band is a first unit of a plurality units wherein said first unit is in parallel with a second unit, the central curve of the first unit and the central curve of the second unit are physically attached to a linking strip.

24. A manufacturing method for a carbon-fiber spring, comprising:
constructing a hard mold made of hard wood or plastic material, said hard mold is carved in shape to produce an elongated sheet band with a curvature configuration, a long dimension, a wide dimension; the long dimension extending from a first edge to a second edge; the wide dimension extending from a third edge and a fourth edge; said long dimension being longer than said wide dimension;
wherein said curvature configuration has a central curve along said long dimension between said first edge and said second edge,
constructing a soft mold insert made of silicone or polymer rubber material, said soft mold insert matching in shape with the hard mold;
placing carbon-fiber composite into the hard mold wherein carbon-fiber filaments are laid along said curvature configuration along the long dimension uni-directionally;
placing said soft-mold insert onto said carbon-fiber composite inside said hard mold in a way that a tight sandwich set is formed wherein said carbon-fiber composite is sandwiched between said hard mold and said soft mold insert, forming a thick dimension of the sheet band ranging from being less than 1/10 of said long dimension;
heating said sandwich set at temperature above 60° C.;
cooling said sandwich set; and
removing said soft mold and said had mold insert.

25. A manufacturing method for a carbon-fiber band-sheet, comprising:
constructing a hard mold made of hard wood or plastic material, said hard mold is carved in a shape to produce an sheet band having said shape;
constructing a soft mold insert made of silicone or polymer rubber material, said soft mold insert matching in shape with the hard mold;
placing carbon-fiber composite into the hard mold wherein carbon-fiber filaments are laid along said shape;
placing said soft-mold insert onto said carbon-fiber composite inside said hard mold in a way that a tight sandwich set is formed wherein said carbon-fiber composite is sandwiched between said hard mold and said soft mold insert, forming a thick dimension of the sheet band.
heating said sandwich set at temperature above 60° C.;
cooling said sandwich set; and
removing said soft mold and said had mold insert.
